(19) United States
(12) Patent Application Publication
(10) Pub. No.: US 2009/0129564 A1
(43) Pub. Date: May 21, 2009

(54) METHOD AND SYSTEM FOR PUBLISHING PRESENCE INFORMATION AND PRESENCE AGENT

(75) Inventors: Ki-soon Sung, Daejeon (KR); Young-il Choi, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/134,734

(22) Filed: Jun. 6, 2008

(30) Foreign Application Priority Data
Nov. 15, 2007 (KR) 10-2007-0116900

(51) Int. Cl. H04M 1/64

(52) U.S. Cl. 379/68; 379/201.01

(57) ABSTRACT

Provided are a method and system for publishing presence information and a presence agent. The method includes receiving a voice message input through a terminal by a user, parsing the received voice message and extracting presence information, and publishing the extracted presence information. According to the method, a user can easily and simply publish presence information without personally using an application program based on presence service. In addition, it is possible to dynamically publish or update presence information.

### CROSS REFERENCE TO RELATED APPLICATIONS

This application claims priority from Korean Patent Application No. 10-2007-0116900, filed on Nov. 15, 2007, the disclosure of which is incorporated herein in its entirety by reference.

### BACKGROUND OF THE INVENTION

1. Field of the Invention

The present invention relates to a communication network service technology, and more particularly, to a method and system for publishing presence information and a presence agent.

This work was supported by the IT R&D program of Ministry of Information and Communication (MIC)/Institute for Information Technology Advancement (IITA) [2005-S-056-03, Development of Open API and Service Platform Technologies].

2. Description of the Related Art

In general, presence service receives and stores information on the status of users registered as subscribers, and transfers the status information of particular user when that user is requested. Here, the status information is information on the current status of a user including whether the user is online or offline, whether or not the user can perform communication, whether or not the user might be on the move, etc.

More specifically, presence information may be classified into information that can be obtained from a network and information that can be obtained from a user according to incoming routes. Here, the information that can be obtained from a network is information on a location or state of a terminal. Such information can be obtained using a positioning technique or sensor technique.

Meanwhile, the presence information obtainable from a user includes a location, activity state, or mood of the user. Here, the information obtainable from a user is information on the user that must be published by the user himself/herself using an application program based on presence service.

In other words, presence information obtainable from a user includes an activity state, mood, location, etc., and thus is difficult to sense using a conventional positioning technique or sensor technique. Therefore, unless a user publishes presence information himself/herself using an application program, it is difficult to obtain the latest presence information on the user.

In particular, when a presence information provider is in a situation in which it is difficult to provide presence information, e.g., on the move or at work, a presence information user, known as a watcher, cannot obtain or refer to the latest presence information on the presence information provider.

Meanwhile, presence service can provide various additional services on the basis of presence information. For example, when presence information includes location information, it is possible to provide additional services such as information on neighboring tourist spots, restaurants, institutions, etc., based on the location information.

However, to provide various presence services as mentioned above, presence information must be correctly obtained. In other words, only when current status information on a presence information provider is correctly obtained, is it possible to timely provide additional service corresponding to the information. Therefore, an apparatus or method for obtaining the latest status information on a presence information provider is required.

### SUMMARY OF THE INVENTION

The present invention provides a method and apparatus for dynamically publishing presence information.

To be specific, the present invention provides a method and apparatus for publishing presence information using a voice message.

Additional aspects of the invention will be set forth in the description which follows, and in part will be apparent from the description, or may be learned by practice of the invention.

The present invention discloses a method of publishing presence information, comprising: receiving a voice message input through a terminal by a user; parsing the received voice message and extracting presence information; and publishing the extracted presence information.

The present invention also discloses a presence agent, comprising: a receiver for receiving a voice message input through a terminal by a user; an extractor for parsing the received voice message and extracting presence information; and a transmitter for transferring the extracted presence information to a presence agent server providing presence service.

The present invention also discloses a system for publishing presence information, comprising: a voice mailbox server for storing a voice message input through a terminal by a user; a presence agent for receiving the stored voice message, parsing the received voice message and extracting presence information; and a presence agent server for receiving the extracted presence information and publishing the received presence information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a system for publishing presence information according to an exemplary embodiment of the present invention.

FIG. 2 is a block diagram of a presence agent according to an exemplary embodiment of the present invention.

FIG. 3 is a flowchart showing a method of publishing presence information according to an exemplary embodiment of the present invention.

FIG. 4 is a flowchart showing a method of transferring presence information according to an exemplary embodiment of the present invention.

FIG. 5 is a signal flowchart showing a method of publishing presence information according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

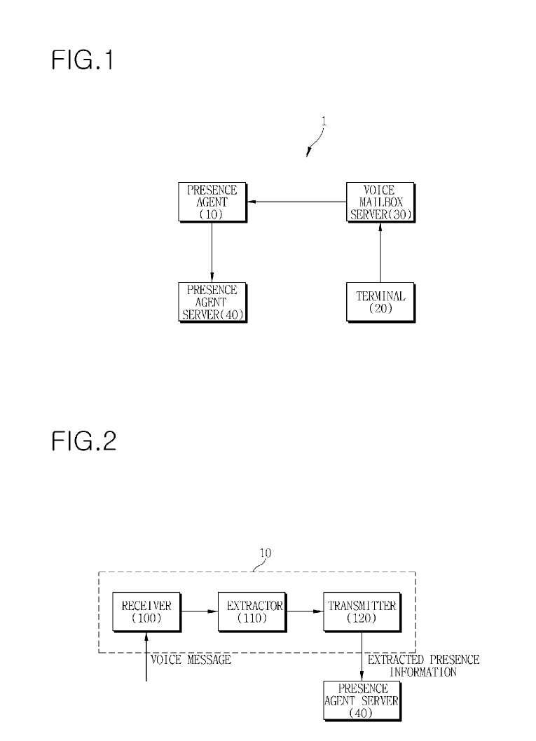

FIG. 1 is a block diagram of a presence information publication system 1 according to an exemplary embodiment of the present invention.

Referring to FIG. 1, the presence information publication system 1 according to an exemplary embodiment of the present invention includes a presence agent 10, a terminal 20, a voice mailbox server 30 and a presence agent server 40.

Here, the presence agent 10, the voice mailbox server 30 and the presence agent server 40 may be implemented in combination or separately.

To provide presence service, the presence information publication system 1 can publish the latest presence information on a “presentity” that is a presence information provider. When a presentity publishes current status information, a watcher who is using presence information on the presentity can refer to the published status information.

More specifically, the presence information publication system 1 according to an exemplary embodiment of the present invention can dynamically publish or update presence information using a voice message. Here, the presence information may be current status information on a presentity.

Meanwhile, the terminal 20 is a means whereby a presence information provider can input a voice message. The terminal may include all devices, such as a cellular phone, a telephone and a Personal Digital Assistant (PDA) phone, whereby a presence information provider can input a voice message.

The voice mailbox server 30 stores a voice message that a user inputs through the terminal 20. The voice mailbox server 30 may be a server provided by a mobile communication company. In addition, the voice mailbox server 30 may transfer the stored voice message to the presence agent 10.

The presence agent 10 receives a voice message input though the terminal 20. In addition, the presence agent 10 may parse the received voice message and extract presence information. Here, the presence agent 10 may receive a voice message stored in the voice mailbox server 30 by the terminal 20.

The presence agent server 40, which is also referred to as a Presence Agent Server (PAS), provides presence service to a user. The presence service is a service authenticated by the Internet Engineering Task Force (IETF) or Third-Generation Partnership Project (3GPP).

The presence agent server 40 receives the presence information extracted by the presence agent 10 and publishes the received presence information. The published presence information may be used for additional presence service.

FIG. 2 is a block diagram of the presence agent 10 according to an exemplary embodiment of the present invention.

Referring to FIG. 2, the presence agent 10 includes a receiver 100, an extractor 110 and a transmitter 120.

The receiver 100 receives a voice message that a user inputs through the terminal 20.

The extractor 110 parses the voice message received through the receiver 100 and extracts presence information. Here, the presence information may include current status information on a presence information provider.

More specifically, the extractor 110 compares a previously set presence attribute value with the parsed voice message and thereby extracts related presence information. Here, the previously set presence attribute value may be presence information defined by IETF or 3GPP. For example, the presence attribute value may be a value classified according to an activity, a mood, a location and a communication state of a user.

Here, the extractor 110 may extract information related to a situation of the presence information provider on the basis of the result of comparing the previously set presence attribute value with the parsed voice message. In other words, the extractor 110 may extract presence information including whether the presence information provider is online or offline, whether or not the presence information provider can perform communication, an activity state, a location, a mood, etc., from the voice message input by the presence information provider.

For example, when the presence information provider inputs a voice message “I'm in a meeting at the office, and I'm depressed because it hasn't ended” through the terminal 20, a speech recognizer of the extractor 110 recognizes the words “office”, “in a meeting” and “depressed”, and may extract status information on the presence information provider by connecting the words with presence attribute values.

In addition, when the extractor 110 compares the previously set presence attribute value with information obtained by parsing the voice message input by the presence information provider, it determines whether status information of “online/offline”, “away”, “at business”, “telephone call” and “meeting” is included in the parsed voice message. When the corresponding status information is included in the parsed voice message, the status information may be extracted.

Meanwhile, the transmitter 120 transfers the presence information extracted by the extractor 110 to the presence agent server 40 providing presence service.

To sum up FIG. 2, the presence information publication system 1 can dynamically publish or update presence information using a voice message. Thus, a presence information provider can publish presence information using a voice message even when it is difficult for the presence information provider to publish presence information in person. Consequently, a watcher can use the latest presence information on the presence information provider. In addition, such dynamic presence information can be provided to a user in connection with additional service.

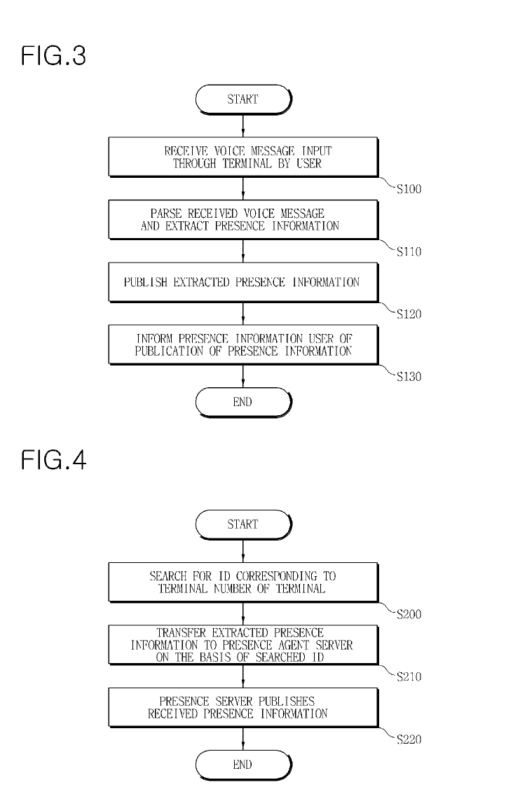

FIG. 3 is a flowchart showing a method of publishing presence information according to an exemplary embodiment of the present invention.

Referring to FIG. 3, the presence agent 10 receives a voice message that a user input through the terminal 20 to publish presence information (operation 100). Here, the voice message may be received from an outside storing the voice message input through the terminal 20. The outside may be the voice mailbox server 30 of a mobile communication company.

Then, the presence agent 10 parses the received voice message and extracts presence information (operation 110). Here, when there is extracted presence information, the extracted presence information can be published (operation 120).

Upon publication, the presence agent 10 transfers the extracted presence information to the presence agent server 40 providing presence service, such that the presence agent server 40 can publish the received presence information.

In addition, the presence agent server 40 may inform a watcher, that is, a presence information user, of publication of presence information (operation 130). In other words, the presence agent server 40 can inform the presence information user subscribing to presence service of the latest presence information on the presentity. The presence agent server 40 receives and stores presence information, and may transfer the corresponding presence information when a request is received from a user registered as a buddy.

Meanwhile, the presence agent server 40 can provide another additional service using published presence information. For example, when presence information extracted from a presence information provider is “traffic jam”, the presence agent server 40 can provide information on a detour around the traffic jam or a shortcut from the presence information provider's location. Therefore, it is possible to provide appropriate presence service for a user on the basis of presence information including the latest status information on the user.

FIG. 4 is a flowchart showing a method of transferring presence information according to an exemplary embodiment of the present invention.

Referring to FIG. 4, the presence agent 10 may transfer extracted presence information to the presence agent server 40. To this end, the presence agent 10 searches for an Identification (ID) corresponding to a terminal number of the terminal 20 from which a voice message is input (operation 200). The presence agent 10 may transfer the extracted presence information to the presence agent server 40 on the basis of the searched ID (operation 210).

Transfer of presence information between the presence agent 10 and the presence agent server 40 may use Session Initiation Protocol (SIP). SIP is a signaling protocol for an application layer specifying a process for searching for a communication counterpart in the Internet and establishing, terminating or changing a multimedia communication session between users. SIP has low complexity and high scalability and thus can be used for presence service.

The presence agent server 40 receiving the presence information using SIP as described above publishes the received presence information or updates presence information with the received presence information (operation 220), and may provide presence service.

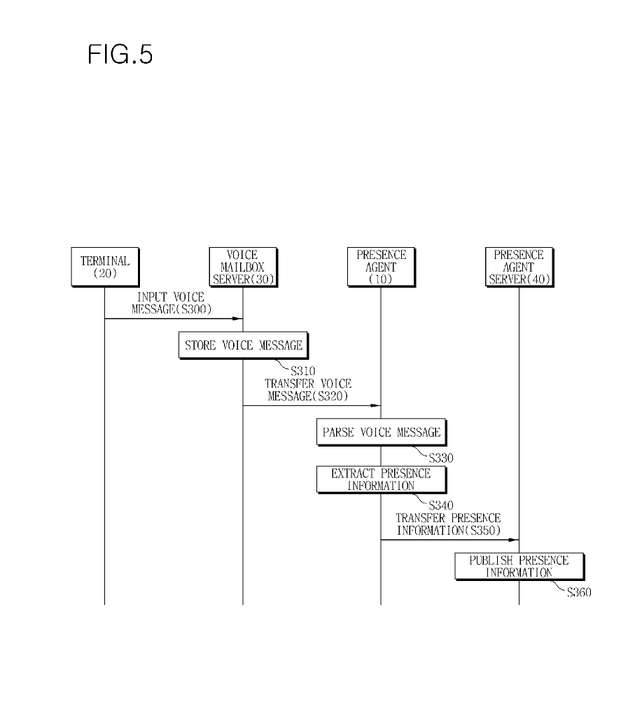

FIG. 5 is a signal flowchart showing a method of publishing presence information according to an exemplary embodiment of the present invention.

Referring to FIG. 5, the terminal 20 inputs a voice message to the voice mailbox server 30 (operation 300). Then, the voice mailbox server 30 may store the input voice message (operation 310). The voice mailbox server 30 transfers the stored voice message to the presence agent 10 (operation 320). Here, the voice mailbox server 30 may be a server of a mobile communication company.

Subsequently, the presence agent 10 receiving the presence information on a presence information provider from the voice mailbox server 30 parses the received voice message (operation 330). And, the presence agent 10 compares a previously set presence attribute value with the parsed voice message and extracts related presence information from the parsed information (operation 340).

Then, the presence agent 10 may transfer the extracted presence information to the presence agent server 40 (operation 350) such that the presence agent server 40 can publish the received presence information (operation 360).

In brief, the presence information publication system according to an exemplary embodiment of the present invention can dynamically publish or update presence information. More specifically, the presence information publication system publishes presence information using a voice message, and thus can publish presence information even in a situation in which it is difficult for a presentity to publish presence information in person. Therefore, a user of the presence information on the presentity can use the latest presence information on the presentity. In addition, it is possible to provide customized additional service related to such dynamic presence information.

As apparent from the above description, the present invention provides a method and apparatus for dynamically publishing or updating presence information.

More specifically, the present invention publishes presence information using a voice message, and thus can simply and dynamically provide the presence information. In addition, a presentity can publish or update presence information using a voice message even in a situation in which it is difficult for the presentity to publish presence information in person, e.g., when in a meeting or on the move. Therefore, a user of the presence information on the presentity can refer to the latest presence information on the presentity.

Furthermore, such dynamic presence information publication enables the user to obtain correct presence information on the presence information provider. Therefore, it is possible to timely provide customized additional service on the basis of the correct presence information.

The present invention can be used in the fields of communication network service and commodity management service in which a presence information publication technique is implemented.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of publishing presence information, comprising:
receiving a voice message input through a terminal by a user;
parsing the received voice message and extracting presence information; and
publishing the extracted presence information.

2. The method of claim 1, wherein the parsing of the received voice message comprises extracting presence information including information on the current status of the user.

3. The method of claim 1, wherein the parsing of the received voice message comprises comparing a previously set presence attribute value with the parsed voice message and extracting related presence information.

4. The method of claim 1, wherein the publishing of the extracted presence information comprises updating the presence information when the extracted presence information is changed.

5. The method of claim 1, wherein the receiving of the voice message comprises receiving the voice message from an outside storing the voice message input through the terminal.

6. The method of claim 1, wherein the publishing of the extracted presence information comprises:
transferring the extracted presence information to a presence agent server providing presence service; and
publishing, at the presence agent server, the received presence information.

7. The method of claim 6, wherein the transferring of the extracted presence information to the presence agent server comprises searching for an Identification (ID) corresponding to a terminal number of the terminal, and transferring the extracted presence information to the presence agent server on the basis of the searched ID.

8. The method of claim 6, wherein the transferring of the extracted presence information to the presence agent server comprises transferring the extracted presence information to the presence agent server using Session Initiation Protocol (SIP).

9. The method of claim 1, further comprising:
generating a message for informing a user of the presence information that the presence information is published.

10. A presence agent, comprising:
a receiver for receiving a voice message input through a terminal by a user;
an extractor for parsing the received voice message and extracting presence information; and
a transmitter for transferring the extracted presence information to a presence agent server providing presence service.

11. The presence agent of claim 10, wherein the extractor extracts presence information including information on the current status of the user.

12. The presence agent of claim 10, wherein the transmitter searches for an Identification (ID) corresponding to a terminal number of the terminal and transfers the extracted presence information to the presence agent server on the basis of the searched ID.

13. A system for publishing presence information, comprising:
a voice mailbox server for storing a voice message input through a terminal by a user;
a presence agent for receiving the stored voice message, parsing the received voice message and extracting presence information; and
a presence agent server for receiving the extracted presence information and publishing the received presence information.
